(19) United States
(12) Patent Application Publication
(10) Pub. No.: US 2013/0091161 A1
(43) Pub. Date: Apr. 11, 2013

(54) Self-Regulating Annotation Quality Control Mechanism

(71) Applicants: Jeffrey Scott McCarley, Bedford Hills, NY (US); Leiming R. Qian, Briarcliff Manor, NY (US)

(72) Inventors: Jeffrey Scott McCarley, Bedford Hills, NY (US); Leiming R. Qian, Briarcliff Manor, NY (US)

(73) Assignee: INTERNATIONAL BUSINESS MACHINES CORPORATION, Armonk, NY (US)

(21) Appl. No.: 13/270,527

(22) Filed: Oct. 11, 2011

(51) Int. Cl. G06F 3/01; G06F 17/30

(52) U.S. Cl. 707/769; 715/751; 707/E17.014

(57) ABSTRACT

A method, apparatus and article of manufacture for determining annotation quality, including obtaining N annotations on an artifact, wherein each annotation includes a feature and N annotations include three or more annotations including an annotation provided by a first human annotator, zero or more human annotations and zero or more imposter annotations, selectively displaying the N annotations to the first human annotator, wherein the annotation provided by the first human annotator is completely visible and each of the other N−1 annotations includes a feature hidden, and determining to annotation quality of one of the N−1 annotations based on input from the first human annotator regarding the displayed annotations, wherein ability of the first human annotator to identify imposter annotations or recognize that no imposter annotation exists is gated by the quality of the first human's annotation via hiding other annotations and requiring a probe based on the first human annotator's annotation.

### FIELD OF THE INVENTION

Embodiments of the invention generally relate to information technology, and, more particularly, to translation quality control.

### BACKGROUND OF THE INVENTION

With respect to annotation technology (for example, translation technology), currently there are three major categories of quality control in existing approaches. The first category includes expert review of a translator's output. Such approaches, however, can be very expensive. The second category includes use of an automatic metric and a comparison against a threshold. Such methods, however, have issues including the following: the threshold may be difficult to establish depending on the application. For example, in machine translation, the threshold may be different depending on the specific text domain.

Also, such existing approaches may emphasize the wrong aspects. For example, a metric in machine translation may over-emphasize fluency with function words. Additionally, in such methods, the worker plays a passive role, as s/he only knows the result of the quality assurance (QA); the score itself does not suggest how s/he can improve his or her work.

The third category includes the use of peer review to judge other peer output. In its conventional form, such methods are limited because a worker will evaluate other workers' output regardless of the quality of his or her own product, and receiving explicit feedback from peers that a worker can use to improve his future work can be difficult or expensive to implement.

Consequently, a need exists for a self-regulating peer review approach to quality control.

### SUMMARY OF THE INVENTION

In one aspect of the present invention, techniques for a self-regulating annotation quality control mechanism are provided. An exemplary computer-implemented method for determining annotation quality can include steps of obtaining N annotations on an artifact from a plurality of annotation sources, wherein each annotation includes at least one feature and wherein the N annotations include three or more annotations, wherein the three or more annotations include an annotation provided by a first human annotator, zero or more other human annotations and zero or more “imposter” annotations, selectively displaying the N annotations to the first human annotator, wherein the annotation provided by the first human annotator is completely visible to the first human annotator and each of the other N−1 annotations includes at least one feature that is hidden from the first human annotator, and determining annotation quality of at least one of the N−1 annotations based on input from the first human annotator regarding the selectively displayed annotations, wherein an ability of the first human annotator to identify an imposter annotation or recognize that no imposter annotation exists in the N annotations is gated by the quality of the first human's own annotation via hiding one or more other annotations and requiring the first human annotator to probe based on the first human annotator's own annotation.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and operative to perform noted method steps. Yet further, another aspect of the invention or elements thereof can be implemented in the form of means for carrying out the method steps described herein, or elements thereof; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an example embodiment, according to an aspect of the invention;

FIG. 2 is a flow diagram illustrating techniques for determining annotation quality, according to an embodiment of the invention; and

FIG. 3 is a system diagram of an exemplary computer system on which at least one embodiment of the invention can be implemented.

### DETAILED DESCRIPTION OF EMBODIMENTS

As described herein, an aspect of the present invention includes a translation quality control mechanism with implicit feedback. One or more embodiments of the invention include producing and using annotations and/or translations. An aspect of the invention includes determining if workers/users are doing a satisfactory job and to steer workers/users toward producing a more satisfactory output product (translation/annotation). As detailed herein, an aspect of the invention provides quality control remedies using a self-regulating peer review approach to quality control.

It should be appreciated that the case of translation is used herein merely as an example, and that the techniques described herein are applicable to a variety of annotators/annotations. In the translation scenario, annotators (who are typically isolated from one another) are given sentences in a source language, and asked to produce corresponding sentences (“annotations of the source sentence”) in a target language. In one aspect of the invention, some of the items to be annotated can be randomly selected as control items and assigned to multiple annotators. The set of items that have received multiple annotations from multiple annotators can form the basis of a quality control.

Using an embodiment of the invention, a worker is also a quality assessor who has already produced the same product. Products from other workers to be evaluated are “hidden” from the assessor (for example, words can be masked as a series of * that indicates the word length) and gradually revealed by the assessor's active probing based on characteristics of his own products. The assessor is informed that there are potentially low quality products (referred to, for example, as “impostors”) injected by the QA process and s/he must identify these impostors via probing. “Imposter” translations can be injected into the QA process, for example, by using machine translation or deliberately mangled human translation.

If a worker produces unsatisfactory products, the QA process can detect such products in two ways: 1) his or her products will often be mistakenly identified as an imposter by fellow assessors, and 2) such a worker may often be ineffective at identifying the imposters because his or her ability to probe will be hindered by the characteristics of his or her own low-quality products.

Accordingly, in contrast to existing peer review mechanisms, one or more embodiments of the invention include using the quality of a worker's/translator's own product/translation in determining his or her effectiveness in assessing other people's work. Also, implicit feedback to improve product/translation quality is learned by the worker during the QA process as he or she learns or identifies the characteristics of his or her own products that enable effective probing (and thus being indications of good quality), without the need for explicit feedback.

Further, in an example embodiment of the invention, the annotator attempts to guess words from a partially hidden view of his or her peer's translation, but can only guess those words that actually appear in his or her own translation.

Additionally, an aspect of the invention can include an interface that presents a set of N translations of the same sentence. By way of example, M translations are from other translators, and N−M translations are low quality “imposter” translations injected by the QA process. The QA proceeds by alternating between two steps: the query step, and the labeling step.

Initially, the translator can only see his or her own translation of the sentence, but none of the words from the other translations (although empty slots that indicate the sentence length and word length for the other translations are visible.) The translator chooses one word/phrase from his or her own translation (the “query term”). The interface indicates which (if any) of the other translations contain the query term, and its locations within those translations. If the query term is not present in any of the other translations, then the translator learns nothing about the other translations. The translator can then label 0 or more sentence as “imposter.” Labeling a translation is easier if some feedback has been received. The translator is immediately told whether the label is correct or not.

The query step and the labeling step can then be repeated until the set of translations is labeled. The translator is rewarded for labeling the sentences correctly in as few queries as possible, but also penalized for incorrect labels. In other words, the translator is encouraged to label as soon as he is confident about a translation, but no sooner.

Accordingly, unlike in conventional peer review systems, the translator's own translation output determines if he or she can be an effective assessor of others, thereby providing incentive for the translator to produce good translations. The translator is encouraged to produce translations that contain words typical of human translations, in order to be able to make useful queries and thus label other translators' translations correctly and efficiently. Translators that have difficulty detecting the imposters can provide an indication that the translator is producing translations that do not have good query terms and may be of lower quality.

With multiple translators labeling each other's sentences, an aspect of the invention can detect if any particular translator's work is frequently labeled as imposter by others—providing an indication for poor translation quality. The query terms selected by the translators are themselves inherently valuable for natural language research, especially machine translation (MT). The words selected by the translators may also be used as part of an automatic metric for measuring the quality of MT. Additionally, aspects of the invention can be implemented even if only one translator is participating, provided that another source of high quality translation is available.

Another aspect of the invention includes image labeling. For example, annotators are given an image and asked to produce a set of words that label (describe) the image. A subset of the images is seen by multiple annotators, and in a peer review phase, the annotators judge the quality of their peers' labels of the same image.

Further, an example embodiment of the invention can be implemented within the context of recipes. For example, a community website may encourage people to contribute recipes for popular dishes. For the same dish, people's recipe can vary, but essential ingredients/steps may often—or indeed, should—be the same. In a peer review phase, contributors review each other's recipe for the same dish implementing the techniques detailed herein. In this example context, during the peer review phase, the contributor must identify the “fake” recipe from other contributor's recipes. The contributor's ability to make this distinction is dependent on the quality of his or her own contributed recipe, as s/he will be asked to use ingredients/steps from his or her own recipe to query other people's recipes.

Accordingly, as detailed herein, an aspect of the invention includes a self-regulating peer-review based quality control process for workers in which the product is subjective (no absolute right or wrong), which includes a peer review phase that includes identifying injected imposter(s). As noted herein, a workers ‘/users’ ability to detect an imposter during peer review is dependent upon his or her own product, and an aspect of the invention includes automatic detection of low-quality product/workers based on inability to detect the imposter (in addition to flagging of low-quality products by the peers).

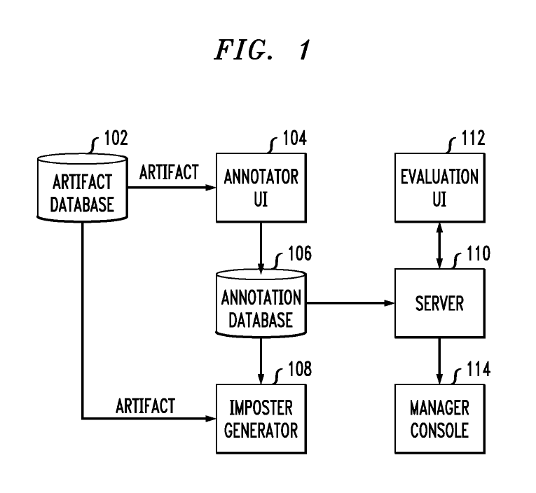

FIG. 1 is a block diagram illustrating an example embodiment, according to an aspect of the invention. By way of illustration, FIG. 1 depicts an artifact database (DB) 102, an annotator user interface (UI) 104, an annotation DB 106, an imposter generator module 108, a server 110, an evaluation UI 112 and a manager console module 114. Artifact DB 102 houses artifacts that are to be annotated. Annotation user interface 104 is used by an annotator (a human annotator) during the annotation stage to annotate an artifact from database 102. The resulting annotated artifact is stored in annotation database 106. Imposter generator module 108 receives an unannotated artifact from database 102 and creates an imposter annotation based thereon. Alternatively, imposter generator module 108 receives an annotation for the artifact in question from database 106 and mangles it to create an imposter.

Server 110 receives human-annotated artifacts from database 106 and receives imposter annotations on the same artifact from the imposter generator module 108. The server provides human-annotated and imposter-annotated artifacts to the evaluation user interface 112 for evaluation. The server also provides instructions to interface 112 regarding which features of which artifacts to display to the user. Evaluation user interface 112 allows the evaluator (the same previous annotator but now during the evaluation phase) to view his own annotations, query the server for features in the hidden annotations, and to render judgments as to which annotations are human and/or imposter. Further, the server reports evaluator judgment statistics to the manager console module 114 so that a supervisor can see how artifacts/annotations are judged by the various annotators. Such provided information can include an annotator's judgments on various annotations, and an annotator's ability to correctly identify imposters and/or recognize a lack of imposters.

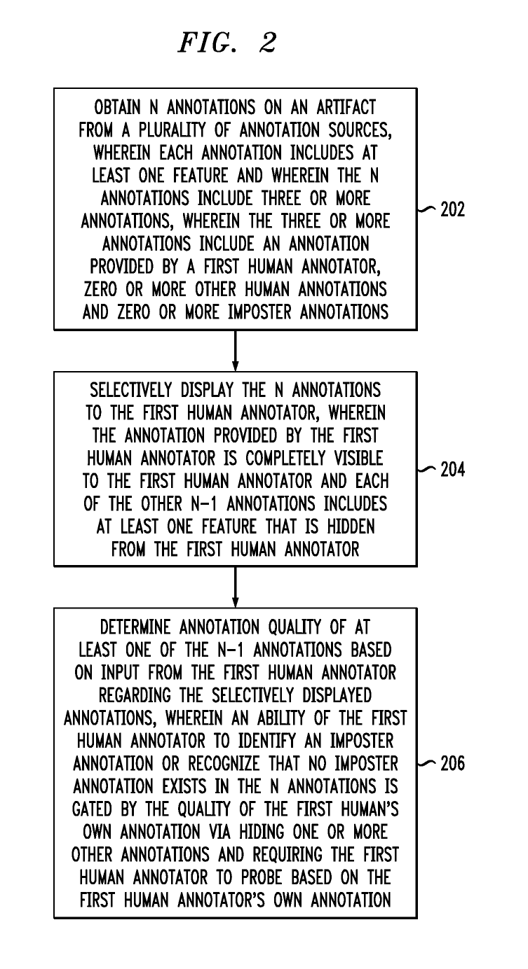

FIG. 2 is a flow diagram illustrating self-regulating techniques for determining annotation quality, according to an embodiment of the present invention. As detailed herein, the annotation can include a translation. Step 202 includes obtaining N annotations on an artifact from a plurality of annotation sources, wherein each annotation includes at least one feature and wherein the N annotations include three or more annotations, wherein the three or more annotations include an annotation provided by a first human annotator, zero or more other human annotations and zero or more imposter annotations. This step can be carried out, for example, using an annotation database, an annotator user interface, and/or an imposter generator module. The N annotations can include at least one annotation from at least one human annotator.

Step 204 includes selectively displaying the N annotations to the first human annotator, wherein the annotation provided by the first human annotator is completely visible to the first human annotator and each of the other N−1 annotations includes at least one feature that is hidden (masked) from the first human annotator. This step can be carried out, for example, using a server and/or an evaluation user interface. Selectively displaying N−1 additional annotations to the first human annotator can include displaying sentence length and word length of an annotation with at least one word masked.

Step 206 includes determining annotation quality of at least one of the N−1 annotations based on input from the first human annotator regarding the selectively displayed annotations, wherein an ability of the first human annotator to identify an imposter annotation or recognize that no imposter annotation exists in the N annotations is gated by the quality of the first human's own annotation via hiding one or more other annotations and requiring the first human annotator to probe based on the first human annotator's own annotation. This step can be carried out, for example, using a server and/or a manager console module. Input from the first human annotator includes a label of at least one of the N−1 annotations with an annotation quality indicator.

As detailed herein, gating the ability of the first human annotator to identify at least one imposter annotation by a quality of the first human's own annotation can include hiding one or more other annotations and requiring the first human annotator to probe based on the first human annotator's own annotation.

As detailed herein, determining annotation quality can be used within a context of translations, gaming, recipes, image labeling, etc. Further, an aspect of the invention additionally includes determining the (average) quality of multiple annotations by a particular human annotator based the human annotator's ability to distinguish imposter annotations.

The techniques depicted in FIG. 2 also include a querying step that includes facilitating the first human annotator to select at least one feature from the annotation provided by the first human annotator as a query term. Additionally, an aspect of the invention further includes applying the query term to search the N annotations and displaying the query term when found in any of the N annotations. Also, an embodiment of the invention includes repeating the querying step and the determining annotation quality of at least one of the N translations based on input from the first human annotator step (that is, the labeling step) until all N translations have been labeled.

The techniques depicted in FIG. 2 can also, as described herein, include providing a system, wherein the system includes distinct software modules, each of the distinct software modules being embodied on a tangible computer-readable recordable storage medium. All the modules (or any subset thereof) can be on the same medium, or each can be on a different medium, for example. The modules can include any or all of the components shown in the figures. In an aspect of the invention, the modules include an artifact database (DB), an annotator user interface (UI), an annotation DB, an imposter generator module, a server, an evaluation UI and a manager console module that can run, for example on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer usable program code that is stored in a computer readable storage medium in a data processing system, and wherein the computer usable program code was downloaded over a network from a remote data processing system. Also, in an aspect of the invention, the computer program product can include computer usable program code that is stored in a computer readable storage medium in a server data processing system, and wherein the computer usable program code are downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and operative to perform exemplary method steps.

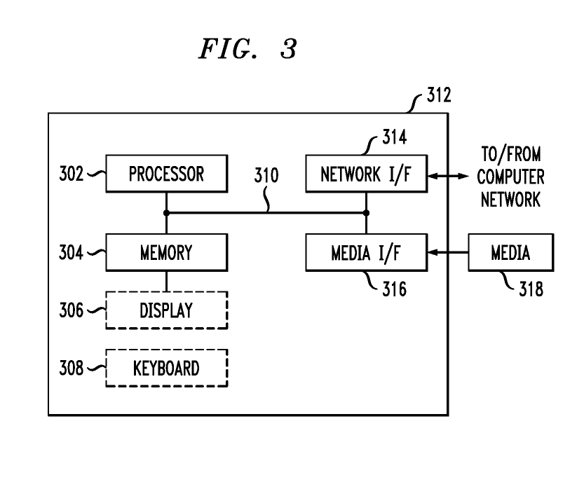

Additionally, an aspect of the present invention can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in an associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As noted, aspects of the present invention may take the form of a computer program product embodied in a computer readable medium having computer readable program code embodied thereon. Also, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components shown in FIG. 1. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

At least one aspect of the present invention may provide a beneficial effect such as, for example, facilitating a user to identify the characteristics of his or her own products that enable effective probing without the need for explicit feedback.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A self-regulating method for determining annotation quality, wherein the method comprises:
obtaining N annotations on an artifact from a plurality of annotation sources, wherein each annotation includes at least one feature and wherein the N annotations include three or more annotations, wherein the three or more annotations include an annotation provided by a first human annotator, zero or more other human annotations and zero or more imposter annotations;
selectively displaying the N annotations to the first human annotator, wherein the annotation provided by the first human annotator is completely visible to the first human annotator and each of the other N−1 annotations includes at least one feature that is hidden from the first human annotator; and
determining annotation quality of at least one of the N−1 annotations based on input from the first human annotator regarding the selectively displayed annotations, wherein an ability of the first human annotator to identify an imposter annotation or recognize that no imposter annotation exists in the N annotations is gated by the quality of the first human's own annotation via hiding one or more other annotations and requiring the first human annotator to probe based on the first human annotator's own annotation;
wherein at least one of the steps is carried out by a computer device.

2. The method of claim 1, further comprising:
determining the quality of multiple annotations by a particular human annotator based the human annotator's ability to distinguish imposter annotations.

3. The method of claim 1, wherein the annotation comprises a translation.

4. The method of claim 1, used within a context of image labeling.

5. The method of claim 1, wherein the artifact comprises a recipe.

6. The method of claim 1, further comprising:
a querying step comprising facilitating the first human annotator to select at least one feature from the annotation provided by the first human annotator as a query term.

7. The method of claim 6, further comprising:
applying the query term to search the N annotations.

8. The method of claim 7, further comprising:
displaying the query term when found in any of the N annotations.

9. The method of claim 1, wherein input from the first human annotator comprises a label of at least one of the N annotations with an annotation quality indicator.

10. The method of claim 9, further comprising:
repeating the querying step and the determining annotation quality of at least one of the N translations based on input from the first human annotator step until all N translations have been labeled.

11. The method of claim 1, further comprising:
providing a system, wherein the system comprises at least one distinct software module, each distinct software module being embodied on a tangible computer-readable recordable storage medium, and wherein the at least one distinct software module comprises an artifact database, an annotator user interface, an annotation database, an imposter generator module, a server, an evaluation user interface and a manager console module executing on a hardware processor.

12. An article of manufacture comprising a computer readable storage medium having computer readable instructions tangibly embodied thereon which, when implemented, cause a computer to carry out a plurality of method steps comprising:
obtaining N annotations on an artifact from a plurality of annotation sources, wherein each annotation includes at least one feature and wherein the N annotations include three or more annotations, wherein the three or more annotations include an annotation provided by a first human annotator, zero or more other human annotations and zero or more imposter annotations;
selectively displaying the N annotations to the first human annotator, wherein the annotation provided by the first human annotator is completely visible to the first human annotator and each of the other N−1 annotations includes at least one feature that is hidden from the first human annotator; and
determining annotation quality of at least one of the N−1 annotations based on input from the first human annotator regarding the selectively displayed annotations, wherein an ability of the first human annotator to identify an imposter annotation or recognize that no imposter annotation exists in the N annotations is gated by the quality of the first human's own annotation via hiding one or more other annotations and requiring the first human annotator to probe based on the first human annotator's own annotation.

13. The article of manufacture of claim 12, wherein the annotation comprises a translation.

14. The article of manufacture of claim 12, wherein the computer readable instructions which, when implemented, further cause a computer to carry out a method step comprising:
determining the quality of multiple annotations by a particular human annotator based the human annotator's ability to distinguish imposter annotations.

15. The article of manufacture of claim 12, wherein the computer readable instructions which, when implemented, further cause a computer to carry out a method step comprising:
a querying step comprising facilitating the first human annotator to select at least one feature from the annotation provided by the first human annotator as a query term.

16. The article of manufacture of claim 15, wherein the computer readable instructions which, when implemented, further cause a computer to carry out a method step comprising:
applying the query term to search the N annotations.

17. The article of manufacture of claim 16, wherein the computer readable instructions which, when implemented, further cause a computer to carry out a method step comprising:
displaying the query term when found in any of the N annotations.

18. The article of manufacture of claim 12, wherein input from the first human annotator comprises a label of at least one of the N annotations with an annotation quality indicator.

19. A system for determining annotation quality, comprising:
at least one distinct software module, each distinct software module being embodied on a tangible computer-readable medium;
a memory; and
at least one processor coupled to the memory and operative for:
obtaining N annotations on an artifact from a plurality of annotation sources, wherein each annotation includes at least one feature and wherein the N annotations include three or more annotations, wherein the three or more annotations include an annotation provided by a first human annotator, zero or more other human annotations and zero or more imposter annotations;
selectively displaying the N annotations to the first human annotator, wherein the annotation provided by the first human annotator is completely visible to the first human annotator and each of the other N−1 annotations includes at least one feature that is hidden from the first human annotator; and
determining annotation quality of at least one of the N−1 annotations based on input from the first human annotator regarding the selectively displayed annotations, wherein an ability of the first human annotator to identify an imposter annotation or recognize that no imposter annotation exists in the N annotations is gated by the quality of the first human's own annotation via hiding one or more other annotations and requiring the first human annotator to probe based on the first human annotator's own annotation.

20. The system of claim 19, wherein the annotation comprises a translation.

21. The system of claim 19, wherein the at least one processor couple to the memory is further operative for:
determining the quality of multiple annotations by a particular human annotator based the human annotator's ability to distinguish imposter annotations.

22. The system of claim 19, wherein the at least one processor coupled to the memory is further operative for:
a querying step comprising facilitating the first human annotator to select at least one feature from the annotation provided by the first human annotator as a query term.

23. The system of claim 22, wherein the at least one processor coupled to the memory is further operative for:
applying the query term to search the N annotations.

24. The system of claim 23, wherein the at least one processor coupled to the memory is further operative for:
displaying the query term when found in any of the N annotations.

25. The system of claim 19, wherein input from the first human annotator comprises a label of at least one of the N annotations with an annotation quality indicator.
